(19) United States
(12) Patent Application Publication
(10) Pub. No.: US 2026/0331838 A1
(43) Pub. Date: Oct. 22, 2026

(54) CONNECTOR ASSEMBLY

(71) Applicant: Molex, LLC, Lisle, IL (US)

(72) Inventors: John C. Laurx, Aurora, IL (US); Marc E. Krause, Darien, IL (US); Michael P. Flynn, Naperville, IL (US); Michael D. Rost, Taipei City (TW); William J. Miller, II, New Lenox, IL (US); Yilin Sung, New Taipei City (TW); Scott Edwards, Little Rock, AR (US)

(21) Appl. No.: 19/486,267

(22) PCT Filed: Apr. 19, 2024
(86) PCT No.: PCT/IB2024/053828

§ 371 Date: Nov. 20, 2025

Related U.S. Application Data
(60) Provisional application No. 63/503,639, filed on May 22, 2023.

(51) Int. Cl. H01R 13/6587; H01R 12/72; H01R 13/6584; H01R 13/6599

(52) U.S. Cl. CPC H01R 13/6587; H01R 12/724; H01R 12/727; H01R 13/6584; H01R 13/6599

(57) ABSTRACT

Connector assemblies for high speed data communication are described. In one example, a connector assembly includes a plug mating interface, a surface mating interface, and a wafer assembly between the plug mating interface and the surface mating interface. The wafer assembly includes a wafer frame, a channel shield, a conductive shield insert positioned around the channel shield, a plurality of signal conductors extending within the channel shield, and a conductive gasket positioned over open edges of the channel shield. The conductive gasket can be embodied by a conductive elastomeric gasket and provides a conductive shield over the open edges of the channel shield. The conductive shield insert is also positioned around a corner region of the channel shield. The conductive gasket and the conductive shield insert help to enclose and surround the open areas in the channel shield and provide additional shielding for the signal conductors.

### RELATED APPLICATIONS

This application claims the benefit of U.S. Provisional Application No. 63/503,639 filed May 22, 2023. The disclosure of the above-identified application is herein incorporated by reference in its entirety.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

High data rate connectors, cable assemblies, and interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signals pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of achieving high data rates using a number of different assembly processes.

### SUMMARY

Various aspects and embodiments of high speed connector assemblies are described. In one example, a connector assembly includes a plug mating interface, a surface mating interface, and a wafer assembly between the plug mating interface and the surface mating interface. The wafer assembly includes a wafer frame, one or more channel shields, a conductive shield insert positioned around the channel shields, a plurality of signal conductors extending within the channel shields, and a conductive gasket and shield plate positioned over open edges of the channel shields. The conductive gasket can be embodied by a conductive elastomeric gasket and provides a conductive shield over the open edges of the channel shields. The conductive shield insert is also positioned around corner regions of the channel shields in some cases. The conductive gasket, shield plate, and the conductive shield insert help to enclose and surround open areas in the channel shields and provide additional shielding for the signal conductors. The additional shielding reduces crosstalk interference, among other benefits, and facilitates higher data throughput through the connector assembly.

In other aspects of the embodiments, each channel shield includes shield sidewalls and a shield discontinuity between the shield sidewalls, and the conductive shield insert is positioned around the shield discontinuity between the shield sidewalls. The connector assembly can include a number of channel shields in each wafer assembly. Each of the channel shields can include shield sidewalls and shield discontinuities between the shield sidewalls. The conductive shield insert can be positioned around the shield discontinuities between the shield sidewalls of each of the channel shields. In this case, the conductive gasket can be positioned over the open edges of each of the channel shields.

In other aspects, the connector assembly can also include a surface interface shield positioned at the surface mating interface of the connector assembly. The surface interface shield can be embodied as a plated plastic. At the surface mating interface of the connector assembly, the channel shield and the plurality of signal conductors extend through an aperture in the surface interface shield. In one example, the surface interface shield includes a grounding bar and a J-lead extending from the grounding bar.

In another embodiment, a wafer assembly includes a wafer frame, a channel shield having a shield discontinuity, a plurality of signal conductors extending within the channel shield, and a conductive shield insert positioned around the shield discontinuity in the channel shield. The conductive shield insert can be positioned around a corner region of the channel shield. The wafer assembly can also include a conductive gasket positioned over open edges of the channel shield. The conductive gasket can be embodied as a conductive elastomeric gasket and provides a conductive shield over the open edges of the channel shield.

In another embodiment, a wafer assembly includes a wafer frame, a channel shield comprising open edges, a plurality of signal conductors extending within the channel shield, and a conductive gasket positioned over the open edges of the channel shield. The conductive gasket can be embodied as a conductive elastomeric gasket and provides a conductive shield over the open edges of the channel shield. The wafer assembly can also include a shield plate, and the conductive gasket can be positioned between the shield plate and the open edges of the channel shield. The wafer assembly can also include a conductive shield insert positioned around the channel shield.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view, including the top, of an example connector assembly according to various aspects of the present disclosure.

FIG. 1B illustrates another perspective view, including the bottom, of the connector assembly shown in FIG. 1A according to various aspects of the present disclosure.

FIG. 2 illustrates the view of the connector shown in FIG. 1A, with parts omitted, according to various aspects of the present disclosure.

FIG. 3A illustrates a perspective view, from a first side, of a wafer assembly in the connector shown in FIG. 1A according to various aspects of the present disclosure.

FIG. 3B illustrates a perspective view, from a second side, of the wafer assembly shown in FIG. 3A according to various aspects of the present disclosure.

FIG. 3C illustrates another perspective view of the wafer assembly shown in FIG. 3F, with parts separated, according to various aspects of the present disclosure.

FIG. 3D illustrates the view of the wafer assembly shown in FIG. 3B, with parts omitted, according to various aspects of the present disclosure.

FIG. 3E illustrates the cross-sectional view of the wafer assembly designated A-A in FIG. 3B according to various aspects of the present disclosure.

FIG. 3F illustrates the channel shields and shield insert of the wafer assembly shown in FIG. 3A according to various aspects of the present disclosure.

FIG. 4A illustrates parts of the bottom of the connector assembly shown in FIG. 1A according to various aspects of the present disclosure.

FIG. 4B illustrates the view designated BB in FIG. 4A according to various aspects of the present disclosure.

FIG. 4C illustrates the view designated CC in FIG. 4B according to various aspects of the present disclosure.

FIG. 4D separately illustrates the surface interface shield of the connector assembly shown in FIGS. 1A and 1B according to various aspects of the present disclosure.

FIG. 5 illustrates another example wafer assembly according to various aspects of the present disclosure.

### DETAILED DESCRIPTION

Connectors are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of high data rates using a range of different assembly processes. It is still challenging, in any case, to design wafers and connectors having the conductor density and small footprint needed for high data rate applications in new systems, while also maintaining the desired electrical characteristics for the transmission of data with integrity.

In the context outlined above, various aspects and embodiments of high speed connector assemblies are described. In one example, a connector assembly includes a plug mating interface, a surface mating interface, and a wafer assembly between the plug mating interface and the surface mating interface. The wafer assembly includes a wafer frame, a channel shield, a plated plastic shield insert positioned around the channel shield, a plurality of signal conductors extending within the channel shield, and a conductive gasket and shield plate positioned over open edges of the channel shield. The conductive gasket can be embodied by a conductive elastomeric gasket and provides a conductive shield over the open edges of the channel shield. The plated plastic shield insert is also positioned around a corner region of the channel shield. The conductive gasket, shield plate, and the plated plastic shield insert help to enclose and surround open areas in the channel shield and provide additional shielding for the signal conductors. The additional shielding reduces crosstalk interference, among other benefits, and facilitates higher data throughput through the connector assembly.

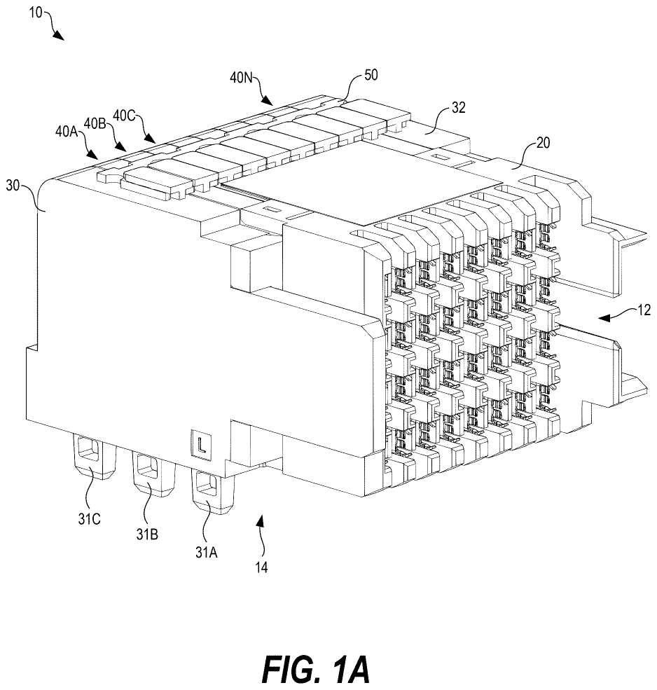

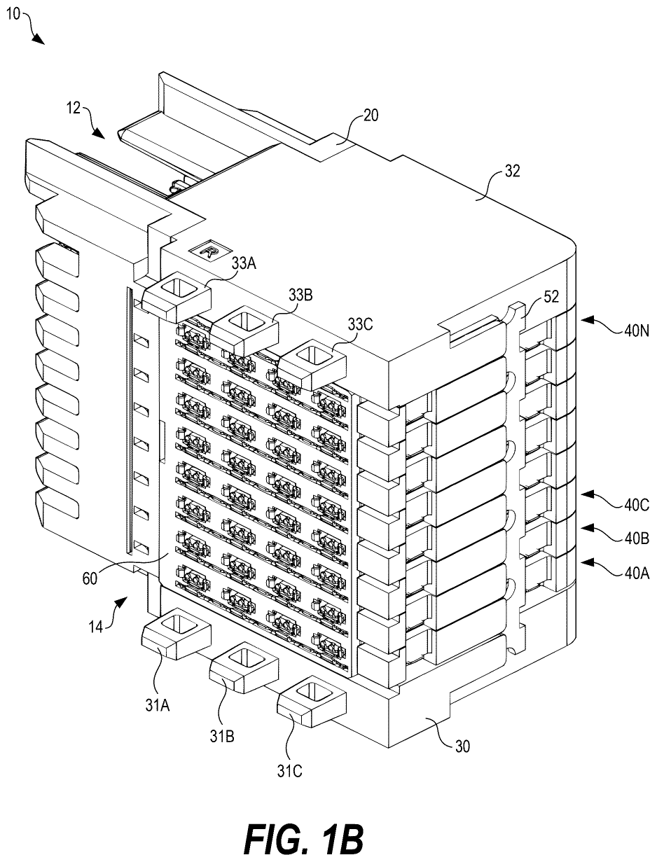

Turning to the drawings, FIG. 1A illustrates a top perspective view of an example connector assembly 10 (also “connector 10”), and FIG. 1B illustrates a bottom perspective view of the connector 10. The connector 10 is illustrated as a representative example and is not drawn to any particular scale or size. The shape, size, proportion, and other characteristics of the connector 10 can vary as compared to that shown. Additionally, while the connector 10 and other connectors discussed herein are described for use in high speed backplane and related interconnect applications, the concepts are not limited to use with such interconnect applications or systems. The concepts can be extended to use in other types of connectors for other types of interconnect applications or systems.

The connector 10 includes a plug mating interface 12 and a surface mating interface 14. In one example, a plug connector can be mated and electrically coupled to the connector 10 at the plug mating interface 12. In another example, the free end of an interconnect system cable can be mated and electrically coupled to the connector 10 at the plug mating interface 12. Additionally, the connector 10 is a hermaphroditic or genderless type of connector. In other words, a duplicate of the connector 10 could be rotated and mated to the connector 10 (i.e., to itself) at the plug mating interface 12.

The surface mating interface 14 of the connector 10 can be mounted and electrically coupled to a printed circuit board (PCB). The connector 10 also includes a plug mate frame 20 at a front end, a first side support 30 at a left side, a second side support 32 at a right side, a number of wafer assemblies, including wafer assemblies 40A, 40B, 40C, and 40N (collectively “wafer assemblies 40”), among others, wafer interlocks 50 and 52, and a surface interface shield 60 (see FIG. 1B). The wafer assemblies 40 are positioned in a side-by-side arrangement between the first side support 30 and the second side support 32. The plug mate frame 20 is positioned over ends of the wafer assemblies 40 in the plug mating interface 12 region of the connector 10. The connector 10 includes eight wafer assemblies 40 in the example shown. The connector 10 can include other numbers of wafer assemblies in other cases, however, including fewer or greater numbers of wafer assemblies.

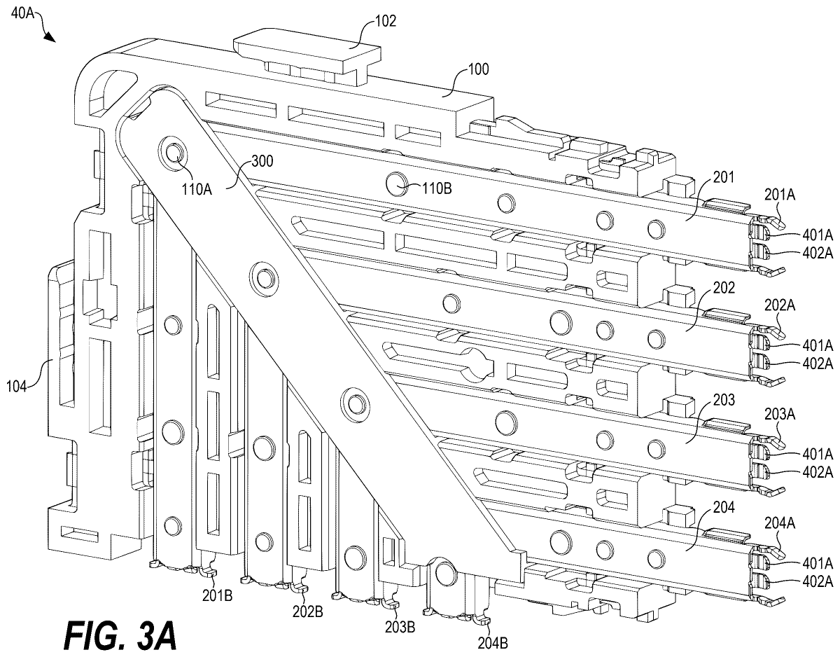

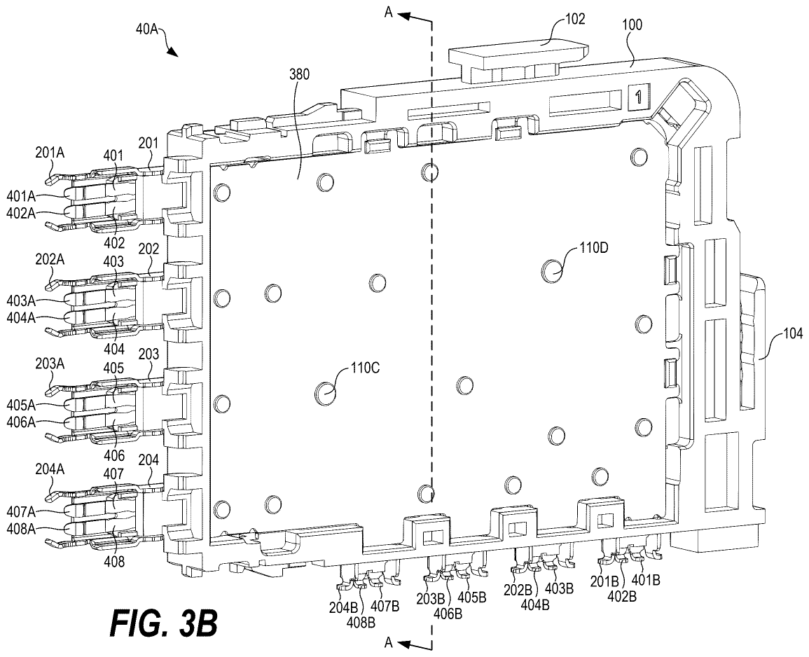

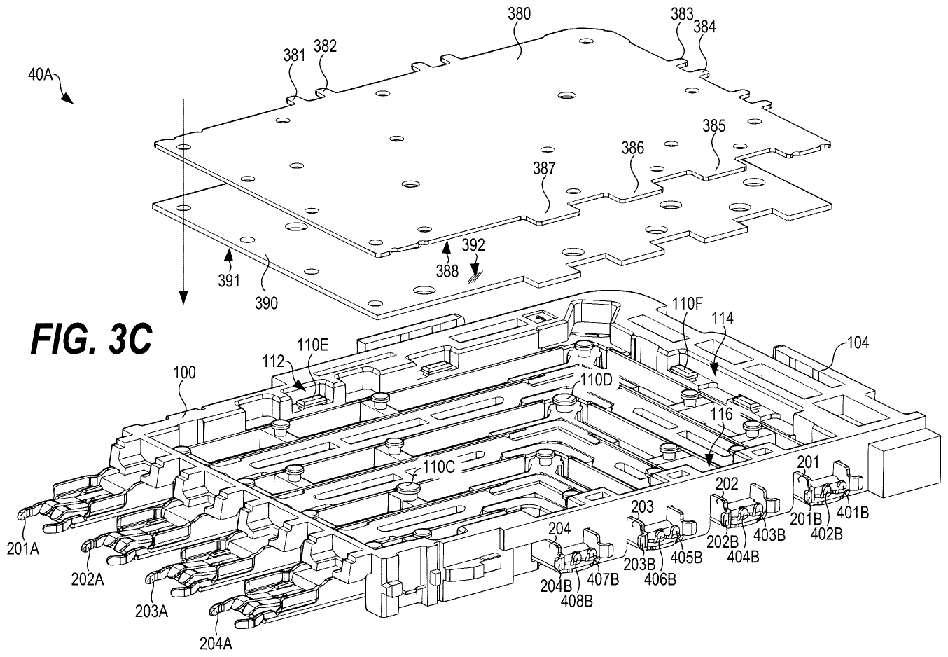

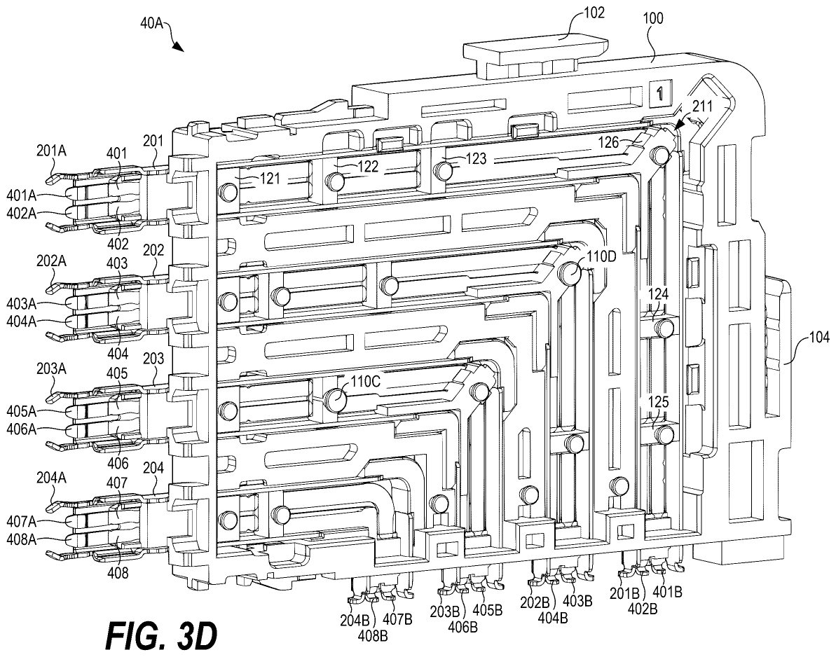

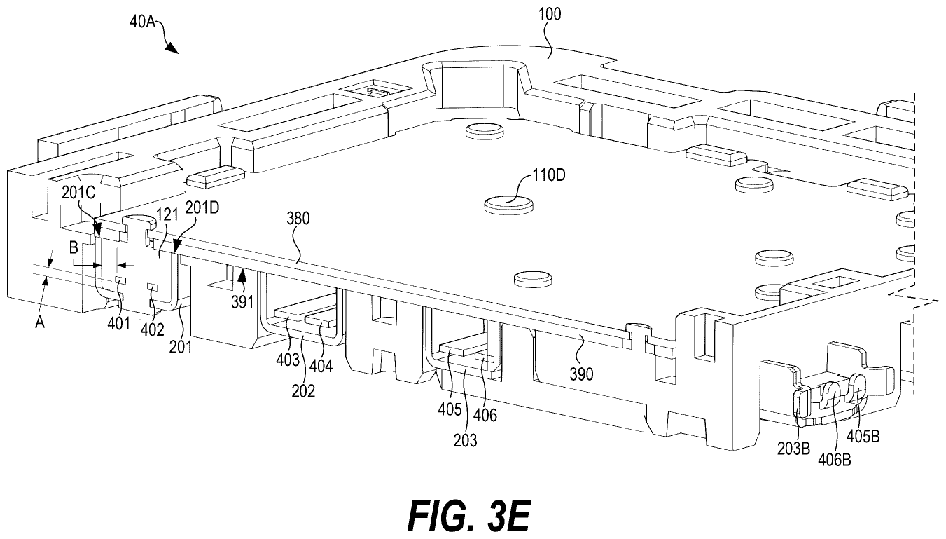

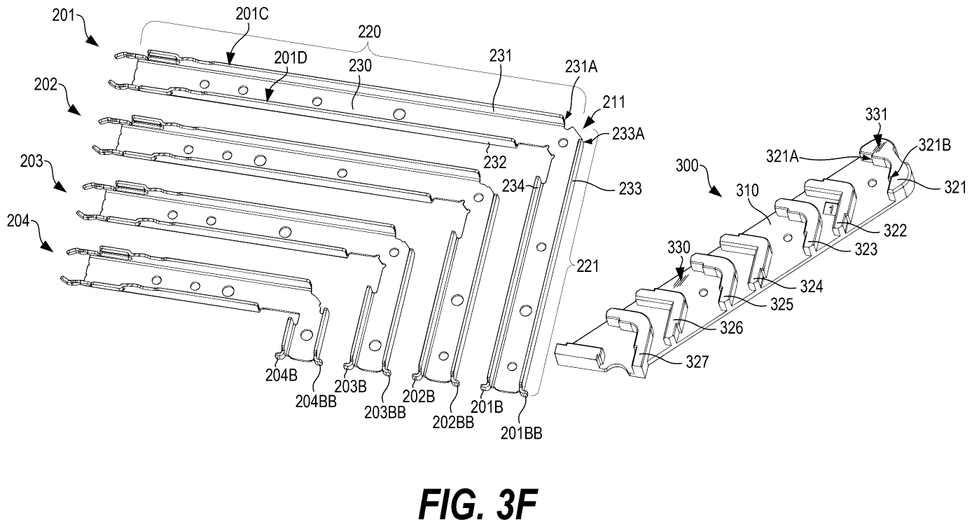

Each of the wafer assemblies 40, which are described in further detail below with reference to FIGS. 3A-3G, includes several pairs of signal conductors and a channel shield for each pair of signal conductors. Each of the wafer assemblies 40 includes four pairs of signal conductors and four channel shields in the examples shown. Each pair of signal conductors extends within a channel of a respective channel shield, and the channel shield provides a common ground and shield for the pair of signal conductors. Each of the wafer assemblies 40 also includes a shield insert formed from a plated plastic material. Each of the wafer assemblies 40 also includes a conductive elastomeric gasket and a shield plate. These and other aspects of the wafer assemblies 40 are described in further detail below.

The first side support 30 and the second side support 32 can be formed from a conductive material, such as a metal or metal alloy, in one example. The first side support 30 and the second side support 32 can be formed from a conductive material, such as a metal or metal alloy, in one example. The first side support 30 and the second side support 32 can be cast (e.g., die cast) or molded from the conductive material or formed using other additive or subtractive manufacturing techniques. In other cases, the first side support 30 and the second side support 32 can be formed from a plastic or polymer material and can be plated with metal or metals in some cases.

The first side support 30 includes support posts 31A-31C. The support posts 31A-31C extend from a bottom surface of the first side support 30 in the surface mating interface 14 region of the connector 10. Similarly, the second side support 32 includes support posts 33A-33C. The support posts 33A-33C extend from a bottom surface of the second side support 32 in the surface mating interface 14 region of the connector 10. Each of the support posts 31A-31C and 33A-33C can be inserted into plated apertures of a PCB, for example, and soldered in place, when the surface mating interface 14 region of the connector 10 is secured upon and electrically coupled to the PCB. The support posts 31A-31C and 33A-33C provide mechanical support to the connector 10 and help to reduce stress on tail contact ends of the signal conductors and the channel shields of the wafer assemblies 40, as described in further detail below, particularly when the connector 10 is mated with a plug connector at the plug mating interface 12.

The plug mate frame 20 can be formed from a plastic or polymer, such as liquid crystal polymer (LCP), polyethylene (PE), polytetrafluoroethylene (PTFE), fluoropolymer, or other plastic or insulating material(s). The plug mate frame 20 can be formed using any suitable additive or subtractive manufacturing techniques, including molding, injection molding, printing, and other techniques. The outer surfaces of the plug mate frame 20 can be plated with a plating metal or metals for conductivity, and the plug mate frame 20 can be embodied as a plated plastic component. The surfaces can be etched in some cases and metalized or plated in a bath, barrel plated, plated by physical vapor deposition (PVD), plated by electroless plating, electroplating, sputter plating, ion plating, or other plating techniques or a combination thereof. The surfaces of the plug mate frame 20 can be metalized or plated with copper, nickel, tin, silver, another other plating metal, or a combination of such plating metals.

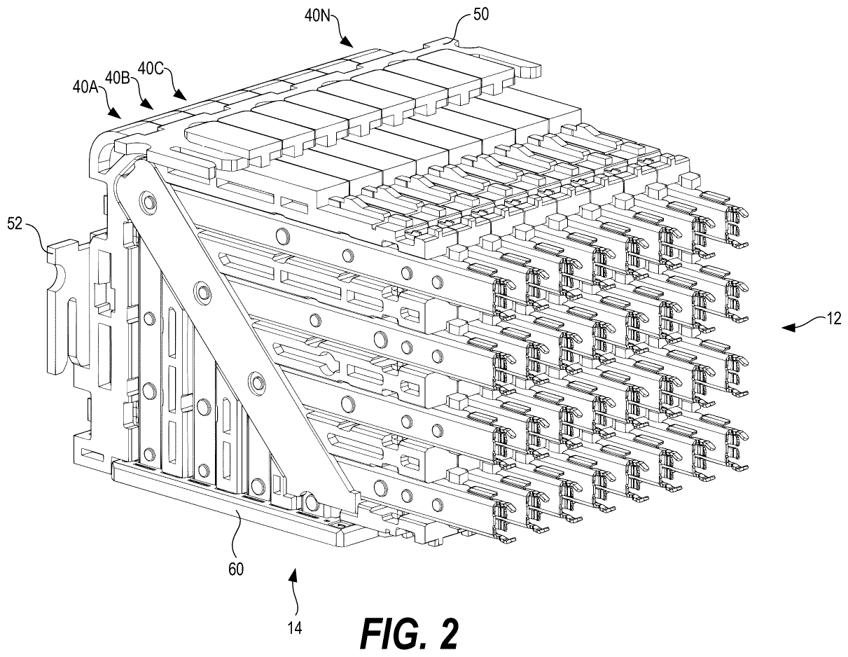

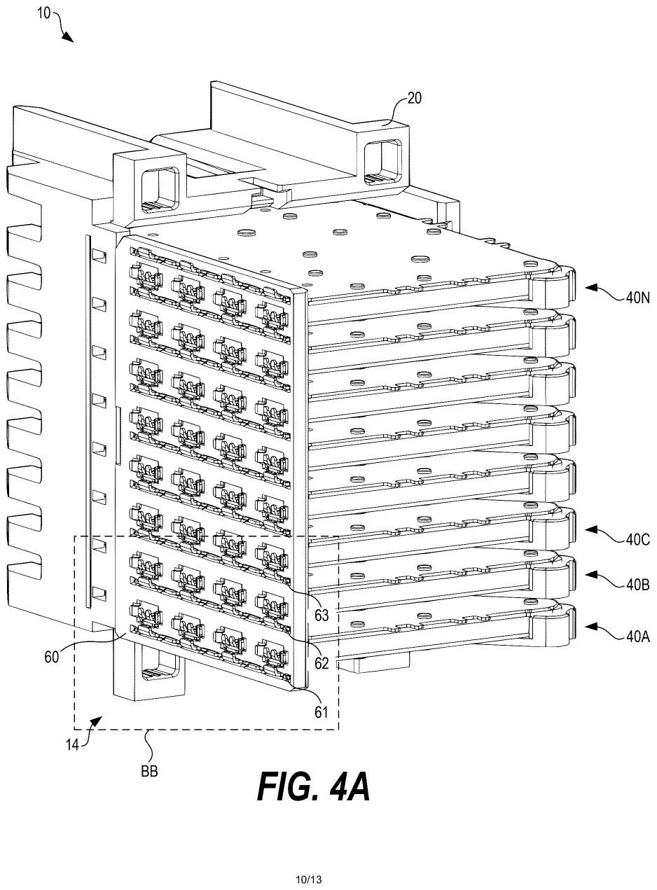

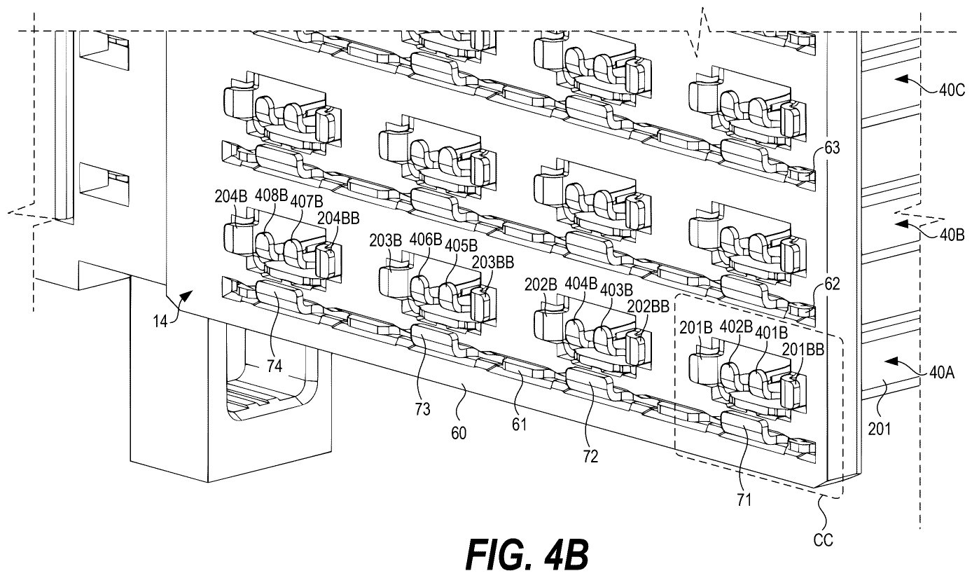

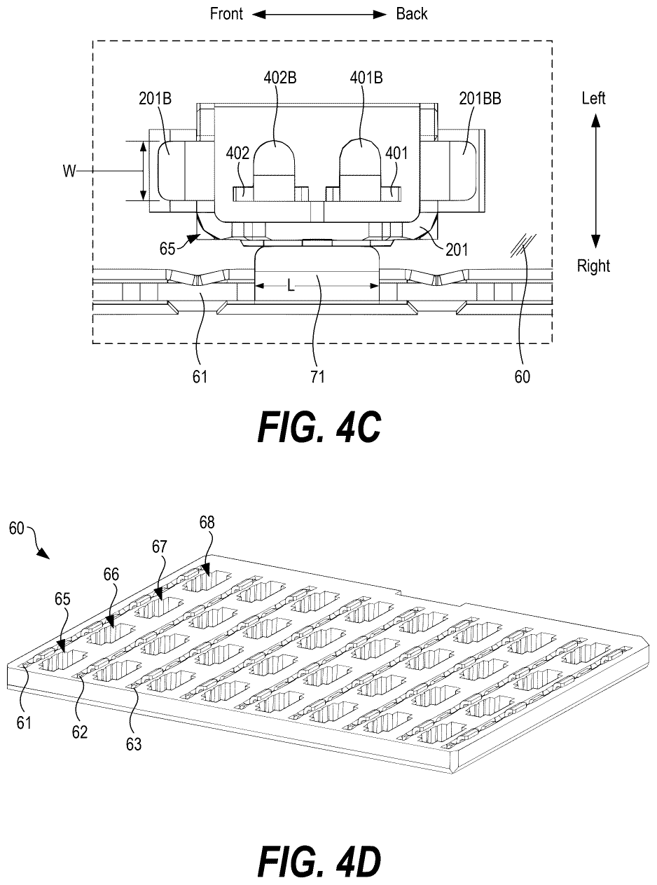

FIG. 2 illustrates the view of the connector 10 shown in FIG. 1A, with parts omitted, according to various aspects of the present disclosure. Particularly, the plug mate frame 20, the first side support 30, and the second side support 32 are omitted from view. The wafer assemblies 40 and the surface interface shield 60 are shown in FIG. 2. The wafer assemblies 40A, 40B, 40C, and 40N, among others, are arranged in a side-by-side arrangement in the connector 10. Aspects of the surface interface shield 60 is described in further detail below with reference to FIGS. 4A-4D.

FIG. 3A illustrates a perspective view, from a first side, of the wafer assembly 40A, and FIG. 3B illustrates another perspective view, from a second side, of the wafer assembly 40A. The wafer assembly 40A is illustrated as a representative example and is not drawn to any particular scale or size. The shape, size, proportion, and other characteristics of the wafer assembly 40A can vary as compared to that shown. Each of the wafer assemblies 40 in the connector 10 can be similar to, and include the same components and features as, the wafer assembly 40A.

Referring between FIGS. 3A and 3B, the wafer assembly 40A includes a wafer frame 100, channel shields 201-204, a shield insert 300, a shield plate 380, and signal conductors 401-408 (see FIG. 3B). The wafer assembly 40A also includes a conductive gasket 390, which is described below with reference to FIG. 3C. The signal conductors 401-408 are conductors for data signals through the connector 10. The channel shields 201-204 are common or ground shields in the connector 10 and, along with the surface interface shield 60 (see FIG. 2), the shield insert 300, the shield plate 380, the conductive gasket 390, and possibly the plug mate frame 20, form a common shield or ground network for the connector 10. The channel shields 201-204 are formed as U-shaped shields in the examples described herein, although the channel shields 201-204 can be formed in other shapes. The channel shields 201-204 also include bends or turns within the connector 10 and, in some regions, have open areas or discontinuities in shielding. The shield insert 300 is relied upon in the connector 10 to close or fill those discontinuities and electrically couple the channel shields 201-204 together, as described in further detail below.

Pairs of the signal conductors 401-408 extend within channels of the channel shields 201-204. Particularly, the signal conductors 401 and 402 extend within a channel of the channel shield 201, the signal conductors 403 and 404 extend within a channel of the channel shield 202, the signal conductors 405 and 406 extend within a channel of the channel shield 203, and the signal conductors 407 and 408 extend within a channel of the channel shield 204. The signal conductors 401-408 include signal lead contact ends 401A-408A, respectively, and signal tail contact ends 401B-108B, respectively. The channel shields 201-204 include shield lead contact ends 201A-204A, respectively, and shield tail contact ends 201B-204B, respectively.

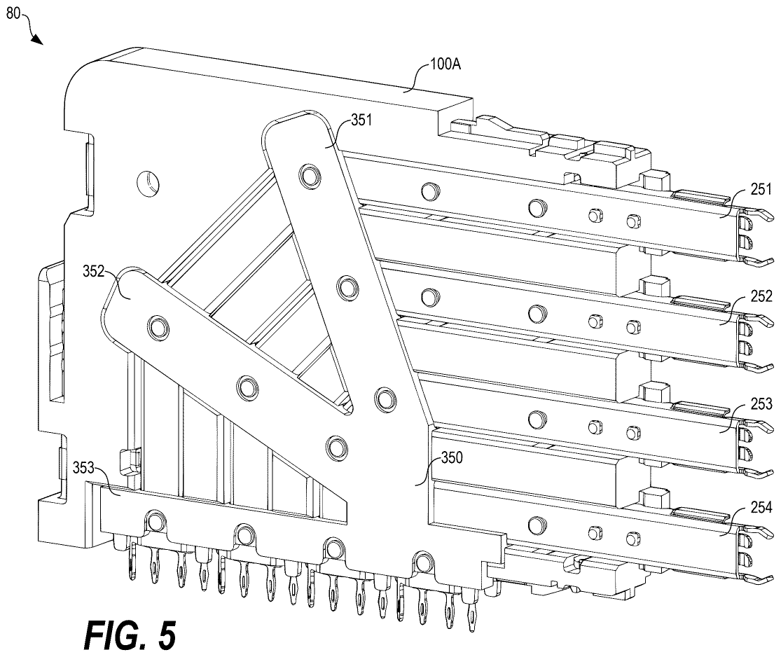

The signal conductors 401-408 can be formed from (e.g., stamped, sheared, or otherwise formed out of) a flat sheet of metal, such as a lead frame. In some cases, the sheet of metal or lead frame can be plated with one or more plating metals. The shapes of the signal lead contact ends 401A-408A and the signal tail contact ends 401B-408B, respectively, can be formed by bending, pressing, or stamping. As described in further detail below with reference to FIG. 4B, the signal tail contact ends 401B-408B are formed into J-leads for surface mount (SMT) coupling to a PCB. In other examples, the signal tail contact ends 401B-408B can be formed as through-hole (e.g., “eye of needle” (EON)) contacts, and examples of signal tail EON contacts in the wafer assemblies 40 are described below with reference to FIG. 5.

The channel shields 201-204 can be separately formed from (e.g., stamped, sheared, or otherwise formed out of) a flat sheet of metal material. The shapes of the shield lead contact ends 201A-204A and the shield tail contact ends 201B-204B, respectively, can be formed by bending, pressing, or stamping. As also described in below with reference to FIG. 4A, the shield tail contact ends 201B-204B are also formed into J-leads for SMT coupling to a PCB. In other examples, the shield tail contact ends 201B-204B can be formed as EON contacts, and examples of shield tail EON contacts in the wafer assemblies 40 are described below with reference to FIG. 5.

The wafer frame 100 can be formed from a plastic or polymer, such as LCP, PE, PTFE, fluoropolymer, or other plastic or insulating material(s). The wafer frame 100 can be molded around the lead frame from which the signal conductors 401-408 are formed, before the signal conductors 401-408 are separated from the larger lead frame. The wafer frame 100 secures and positions the conductors 401-408 with respect to each other and with respect to the other components of the wafer assembly 40A, including with respect to the channel shields 201-204, the shield plate 380, and the conductive gasket 390. Among other features described below, the wafer frame 100 includes a number of conductor bumpers that are sized to fit into the U-shaped channels within the channel shields 201-204. The conductor bumpers maintain the positions and spacings of the signal conductors 401-408 within the channels of the channel shields 201-204. When the wafer frame 100 is first molded around the signal conductors 401-408, the wafer frame 100 includes a number of staking posts. The staking posts are used to secure the components of the wafer assembly 40A together, as described below.

After the wafer frame 100 is formed around the signal conductors 401-408 of the lead frame, the channel shields 201-204 can be inserted into the assembly including the wafer frame 100 and signal conductors 401-408. The channel shields 201-204 include a number of apertures or openings, and the channel shields 201-204 can be assembled such that the staking posts of the wafer frame 100 extend through the apertures of the channel shields 201-204. The shield insert 300 can also be formed separately, as described below, and inserted into the assembly between the channel shields 201-204, in the position shown in FIG. 2A. Additionally, the shield plate 380 and the conductive gasket 390 can be inserted into the assembly in the position shown in FIG. 3B. After the channel shields 201-204, the shield insert 300, the shield plate 380, and the conductive gasket 390 are assembled with the wafer frame 100 and the signal conductors 401-408, a separate heat staking process step can be performed to secure the wafer assembly 40A together. Particularly, the staking posts of the wafer frame 100 are heat staked and remolded, in part, to form staking caps in a separate process step. A number of staking caps, such as the staking caps 110A-110D, among others, are illustrated in FIGS. 3A and 3B. The staking caps 110A-110D secure the channel shields 201-204, the shield plate 380, and the conductive gasket 390 together with the wafer frame 100 and the signal conductors 401-408, to hold the wafer assembly 40A together.

The wafer frame 100 includes frame stakes 102 and 104. The wafer interlocks 50 and 52 (see FIG. 2) include a number of fingers and can be formed from (e.g., stamped, sheared, or otherwise formed out of) a flat sheet of metal as one example. The fingers of the wafer interlocks 50 and 52 are inserted among the frame stakes 102 and 104 of the wafer frame 100, as well as among similar frame stakes of all the wafer assemblies 40, to help secure the connector 10 together. The fingers of the wafer interlocks 50 and 52 are also inserted among frame stakes of the first and second side supports 30 and 32 in the connector 10, as shown in FIGS. 1A and 1B.

FIG. 3C illustrates another perspective view of the wafer assembly 40A, with parts separated. As shown in FIG. 3C, the wafer assembly also includes the conductive gasket 390. The conductive gasket 390 is interposed between the shield plate 380, on one side, and surfaces of the wafer frame 100, the channel shields 200A-200D, and the shield insert 300, on another side. The conductive gasket 390 can be formed from a conductive elastomeric or foam material. The conductive gasket 390 is elastic and compressible to some extent. As one example, the conductive gasket 390 can be embodied as a polyurethane foam multi-laminate including conductive materials, such as copper, nickel, or other conductive metals or materials. In one particular example, the conductive gasket 390 can be embodied as the P-SHIELD® brand PS-1323 conductive foam or conductive foam tape or sheet manufactured by Polymer Science, Inc. of Monticello, Indiana, although other suitable types of conductive elastomeric or foam materials can be relied upon. The conductive gasket 390 can range in thickness from between 0.1-3 mm, and example thicknesses include 0.5 mm, 1.0 mm, 1.5 mm, 2.0 mm, 2.5 mm, 2.5 mm, and 3.0 mm, although other thicknesses can be relied upon.

The shield plate 380 can be formed from (e.g., stamped, sheared, or otherwise formed out of) a flat sheet of metal or other conductive material. The shield plate 380 can range in thickness from between 0.5-2 mm, and example thicknesses include 0.5 mm, 1.0 mm, 1.5 mm, and 2.0 mm, although other thicknesses can be relied upon. The outline shape (i.e., the peripheral edge shape or outline) of the shield plate 380 can be the same as that of the conductive gasket 390 in one example. However, the conductive gasket 390 can be smaller than the shield plate 380 in some cases.

The shield plate 380 includes positioning fingers 381 and 382, among others, extending from a first peripheral edge of the shield plate 380 and positioning fingers 383 and 384, among others, extending from a second peripheral edge of the shield plate 380. The shield plate 380 also includes a number of positioning tabs 385-387, among others, extending from a third peripheral edge. The wafer frame 100 includes recess seats 112, 114, and 116, among others. The positioning fingers 381 and 382 of the shield plate 380 can rest upon surfaces in the recess seat 112 of the wafer frame 100. Within the recess seat 112, the staking cap 110E of the wafer frame 100 can partly cover and hold the positioning fingers 381 and 382. The positioning fingers 383 and 384 can rest upon surfaces in the recess seat 114. Within the recess seat 114, the staking cap 110F of the wafer frame 100 can partly cover and hold the positioning fingers 383 and 384. Additionally, the positioning tab 386 can rest upon surfaces in the recess seat 116, and the positioning tabs 385 and 387 can rest upon surfaces in other recess seats that are formed in the wafer frame 100.

Both the conductive gasket 390 and the shield plate 380 include a number of apertures or openings, and the staking posts of the wafer frame 100 can extend through the apertures during assembly of the wafer assembly 40A, before the staking posts are heat staked to form the staking caps 110C and 110D, among others, over the shield plate 380. The positions and arrangement of the apertures through the conductive gasket 390 and the shield plate 180 are illustrated as a representative example, and other configurations can be relied upon.

A conductive adhesive can be applied between the top surface 392 of the conductive gasket 390 and the bottom surface 388 of the shield plate 380, to hold the conductive gasket 390 together with the shield plate 380. Together, the conductive gasket 390 and the shield plate 380 are relied upon to enclose and, to the extent possible, seal open edges of the channel shields 201-204 within the center of the wafer frame 100. That is, the conductive gasket 390 and the shield plate 380 help to enclose and shield the signal conductors 401-408 that extend within the channel shields 201-204. Both the conductive gasket 390 and the shield plate 380 are conductive and are electrically coupled to a common or ground network in the connector 10. Thus, the conductive gasket 390 and the shield plate 380 provide a type of electromagnetic radiation shield, reducing crosstalk coupling and related signal interference among the signal conductors 401-408 in the connector 10.

Due to manufacturing tolerances and related factors, the open edges along the U-shaped channel shields 201-204 do not necessarily lie in the exact same plane. Due to its elastomeric properties, the conductive gasket 390 can be compressed against the open edges of the U-shaped channel shields 201-204, making continuous contact across and along the open edges, even if the edges do not lie in the exact same plane. The conductive gasket 390 achieves a better seal and closure along the open edges of the channel shields 201-204 than the shield plate 380 could make alone. The enhanced shielding provided by the conductive gasket 390 helps to maintain signal integrity on the signal conductors 401-408 and facilitates higher data throughput for the connector 10. The conductive properties of the conductive gasket 390 also electrically couples and commons potentials among the channel shields 201-204. The shield insert 300 also helps to enclose the channel shields 201-204, as described below.

FIG. 3D illustrates the view of the wafer assembly 40A shown in FIG. 3B, with parts omitted. The shield plate 380 and conductive gasket 390 are omitted from view in FIG. 3D. As shown, pairs of the signal conductors 401-408 extend within channels of the channel shields 201-204. Particularly, the signal conductors 401 and 402 extend within a channel of the channel shield 201, the signal conductors 403 and 404 extend within a channel of the channel shield 202, the signal conductors 405 and 406 extend within a channel of the channel shield 203, and the signal conductors 407 and 408 extend within a channel of the channel shield 204. The signal conductors 401-408 include signal lead contact ends 401A-408A, respectively, and signal tail contact ends 401B-108B, respectively. The channel shields 201-204 include shield lead contact ends 201A-204A, respectively, and shield tail contact ends 201B-204B, respectively.

Conductor bumpers 121-123 are positioned within the U-shaped channel of the channel shield 201, between the shield lead contact end 201A and the corner region 211 of the channel shield 201. Conductor bumpers 124 and 125 are positioned within the U-shaped channel of the channel shield 201, between the corner region 211 and the shield tail contact end 201B of the channel shield 201. Additionally, a corner bumper 126 is positioned in the corner region 211 of the channel shield 201. The conductor bumpers 121-126 surround the signal conductors 401 and 402 and maintain a separation distance between the channel shield 201 and the signal conductors 401 and 402.

The conductor bumpers 121-126 are originally formed as part of the larger wafer frame 100 when the wafer frame 100 is molded around the signal conductors 401 and 402. Subsequently, the conductor bumpers 121-126 are separated (i.e., cut or severed) from the remainder of the wafer frame 100 before the channel shield 201 is inserted around the signal conductors 401 and 402. The wafer assembly 40A also includes a number of other conductor bumpers that are positioned in each of the U-shaped channels of the channel shields 202-204.

FIG. 3E illustrates the cross-sectional view of the wafer assembly 40A designated A-A in FIG. 3B. FIG. 3E shows how the conductive gasket 390 is positioned between the shield plate 380 and the open edges of the channel shields 201-203. The conductive gasket 390 and shield plate 380 are staked and secured in place by a number of staking caps, including the staking cap 110D, among others. The bottom surface 391 of the conductive gasket 390 contacts the open top edges 201C and 201D of the U-shaped channel shield 201. In a similar way, the conductive gasket 390 contacts the top edges of the channel shields 202, 203, and 204 (not shown in FIG. 3E).

The conductor bumper 121 and signal conductors 401 and 402 are also shown positioned within the channel shield 201 in FIG. 3E. The conductor bumper 121 surrounds the signal conductors 401 and 402 and maintains a separation distance between the channel shield 201 and the signal conductors 401 and 402. For example, the conductor bumper 121 maintains the separation distance “A” between the inner lower surface within the U-shaped channel shield 201 and the bottom surfaces of the signal conductors 401 and 402. The conductor bumper 121 also maintains the separation distance “B” between the inner side surfaces of the U-shaped channel shield 201 and the side surfaces of the signal conductors 401 and 402. The conductor bumper 121 is heat staked both over the upper surface of the shield plate 380 and below the lower surface of the channel shield 201.

As noted above, due to manufacturing tolerances and related factors, the open edges along the U-shaped channel shields 201-204 do not necessarily lie in the exact same plane. However, the conductive gasket 390 can be compressed against the open edges of the U-shaped channel shields 201-204, such as against the open top edges 201C and 201D of the U-shaped channel shield 201, making continuous contact across and along the open edges, even if the edges do not lie in the exact same plane. The conductive gasket 390 achieves a better seal and closure along the open edges of the channel shields 201-204 than the shield plate 380 could make alone. The enhanced shielding provided by the conductive gasket 390 helps to maintain signal integrity on the signal conductors 401-408 and facilitates higher data throughput for the connector 10. The conductive properties of the conductive gasket 390 also electrically couples and commons potentials among the channel shields 201-204.

Turning to other aspects of the embodiments, FIG. 3F separately illustrates the channel shields 201-204 and shield insert 300 of the wafer assembly 40A shown in FIG. 3A. The channel shield 201 includes a first region 220 of extension and a second region 221 of extension. The first region 220 extends substantially orthogonal to (e.g., at a 90° angle from) the second region 221. The channel shield 201 includes a bottom shield wall 230 which extends continuously and integrally from the first region 220 to the second region 221. In the first region 220, the channel shield 201 also includes a first shield sidewall 231 that extends up from one edge of the bottom shield wall 230 and a second shield sidewall 232 that extends up from another edge of the bottom shield wall 230. In the second region 221, the channel shield 201 includes a third shield sidewall 233 that extends up from one edge of the bottom shield wall 230 and a fourth shield sidewall 234 that extends up from another edge of the bottom shield wall 230. While the bottom shield wall 230 of the channel shield 201 extends continuously from the first region 220 to the second region 221, the shield sidewalls of the channel shield 201 to not extend continuously between the first region 220 and the second region 221. Instead, the first shield sidewall 231 and the third shield sidewall 233 are separated in the corner region 211 of the channel shield 201. Additionally, the second shield sidewall 232 and the fourth shield sidewall 234 are separated in the corner region 211 of the channel shield 201.

Although formed to different sizes, each of the channel shields 202-204 is similar to the channel shield 201 and includes discontinuities between the shield sidewalls of the channel shields 202-204 in the corner regions of the channel shields 202-204. The discontinuities between the shield sidewalls of the channel shields 201-204 are covered or closed by the shield insert 300 in the wafer assembly 40A, to provide a type of shield against electromagnetic radiation, reducing crosstalk coupling and related signal interference among the signal conductors 401-408 in the connector 10.

The shield insert 300 can be embodied as a conductive shield insert. The shield insert 300 can be formed from a plated plastic material. For example, the shield insert 300 can be formed from LCP, PE, PTFE, or other plastic material and, in some cases, a include additives to which plating metal or metals will better adhere. The shield insert 300 can be formed using any suitable additive or subtractive manufacturing techniques, including molding, injection molding, printing, and other techniques. The outer surfaces of the shield insert 300 can be plated with a plating metal or metals for conductivity, and the shield insert 300 can be embodied as a plated plastic component. The surfaces can be etched in some cases and metalized or plated in a bath, barrel plated, plated by physical vapor deposition (PVD), plated by electroless plating, electroplating, sputter plating, ion plating, or other plating techniques or a combination thereof. The surfaces of the shield insert 300 can be metalized or plated with copper, nickel, tin, silver, another other plating metal, or a combination of such plating metals.

The shield insert 300 includes a shield arm 310 and a number of shield cap extensions 321-327. The shield cap extensions 321-327 are spaced apart and extend up from the shield arm 310. The shield insert 300 is designed in shape and size to fit into the corner regions of the channel shields 201-204 and cover the discontinuities between the shield sidewalls of the channel shields 201-204. For example, the shield cap extensions 321 and 322 cover and fit into the discontinuities between the shield sidewalls 231-234 in the corner region 211 of the channel shield 201. The shield cap extensions 323 and 324 cover and fit into the discontinuities between the shield sidewalls in the corner region of the channel shield 202. The shield cap extensions 325 and 326 cover and fit into the discontinuities between the shield sidewalls in the corner region of the channel shield 203. Additionally, the shield cap extensions 326 and 327 cover and fit into the discontinuities between the shield sidewalls in the corner region of the channel shield 204.

The shield insert 300 can be press fit among and held in place by mechanical interferences between the channel shields 201-204 and the shield insert 300. In some cases, the end edges of the shield sidewalls can include bumps or detents. For example, the end edges 231A and 233A of the shield sidewalls 231 and 233 can include one or more bumps or detents. The end edges 231A and 233A can be positioned into the notches 321A and 321B in the shield cap extension 321, to help secure the shield insert 300 at the corner region 211 of the channel shield 201. The other end edges of the shield sidewalls can also include bumps or detents for positioning into notches formed in the shield cap extensions 322-327. Additionally, the shield insert 300 can be staked in place by stake posts of the wafer frame 100.

When inserted among the channel shields 201-204, the top surface 330 of the shield arm 310 contacts the bottom or back surfaces of each of the channel shields 201-204. Thus, the shield insert 300 provides an electrical connection among the channel shields 201-204. Additionally, the top surfaces of the shield cap extensions 321-327, such as the top surface 331 of the shield cap extension 321, make contact with the conductive gasket 390 when the wafer assembly 40A is assembled as shown in FIGS. 3A and 3B.

FIG. 4A illustrates parts of the bottom of the connector assembly 10 shown in FIG. 1A. The wafer frames of the wafer assemblies 40, the first side support 30, and the second side support 32 are omitted from view in FIG. 4A, so that the surface interface shield 60 is visible. The surface interface shield 60 can be formed from a plated plastic material. For example, the surface interface shield 60 can be formed from LCP, PE, PTFE, or other plastic material and, in some cases, a include additives to which plating metal or metals will better adhere. The surface interface shield 60 can be formed using any suitable additive or subtractive manufacturing techniques, including molding, injection molding, printing, and other techniques. The outer surfaces of the surface interface shield 60 can be plated with a plating metal or metals for conductivity, and the surface interface shield 60 can be embodied as a plated plastic component.

The surfaces can be etched in some cases and metalized or plated in a bath, barrel plated, plated by PVD, plated by electroless plating, electroplating, sputter plating, ion plating, or other plating techniques or a combination thereof. The surfaces of the surface interface shield 60 can be metalized or plated with copper, nickel, tin, silver, another other plating metal, or a combination of such plating metals.

The surface interface shield 60 provides additional shielding at the surface mating interface 14 of the connector 10. The surface interface shield 60 includes a number of grounding bars, including the grounding bars 61-63, among others. The plated plastic material of the surface interface shield 60 can be molded around the grounding bars 61-63. The surface interface shield 60 includes one grounding bar for each of the wafer assemblies 40 in the connector 10, and the grounding bars are aligned with the wafer assemblies 40, as described in further detail below with reference to FIG. 4B. The grounding bars in the surface interface shield 60 help to reduce in-column crosstalk among the signal conductors in each of the wafer assemblies 40. The grounding bars in the surface interface shield 60 also include SMT J-leads, which are aligned and positioned with the signal tail contact ends of the signal conductors in the wafer assemblies 40. The J-leads are sized and positioned to reduce cross-column crosstalk among the signal conductors between the wafer assemblies 40.

The surface interface shield 60 includes a number of apertures or openings, and the tail ends of the channel shields of each of the wafer assemblies 40 extend through the apertures or openings, as shown in FIG. 4A. The channel shields of each of the wafer assemblies 40 contact outer surfaces of the surface interface shield 60, and the channel shields in the connector 10 are electrically coupled to the surface interface shield 60. Thus, the surface interface shield 60 electrically couples all the channel shields of the wafer assemblies 40 together at the surface mating interface 14 of the connector 10.

FIG. 4B illustrates the view designated BB in FIG. 4A. As shown, the signal tail contact ends 401B-408B of the signal conductors 401-408 of the wafer assembly 40A extend through apertures in the surface interface shield 60. Each of the signal tail contact ends of the signal conductors of the other wafer assemblies 40 in the connector 10 also extend through apertures in the surface interface shield 60. The signal tail contact ends 401B-408B and signal tail contact ends of the other signal conductors in the connector 10 are formed as SMT J-leads.

The shield tail contacts ends of the channel shields of each of the wafer assemblies 40 also extend through the apertures in the surface interface shield 60. The shield tail contact ends of the channel shields in the connector 10 are formed as SMT J-leads. For example, the channel shields 201-204 of the wafer assembly 40A include shield tail contact ends 201B-204B and 201BB-204BB. The shield tail contact ends 201B-204B and 201BB-204BB extend through the apertures in the surface interface shield 60. The shield tail contact ends 201B-204B and 201BB-204BB of the channel shields 201-204 are also shown and individually referenced in FIG. 3F. Each of the shield tail contact ends of the channel shields of the other wafer assemblies 40 in the connector 10 also extend through apertures in the surface interface shield 60.

The surface interface shield 60 provides additional shielding at the surface mating interface 14 of the connector 10. The surface interface shield 60 includes a number of grounding bars, including the grounding bars 61-63, among others. The plated plastic material of the surface interface shield 60 can be molded around the grounding bars 61-63. The surface interface shield 60 includes one grounding bar for each of the wafer assemblies 40 in the connector, and the grounding bars are aligned with the wafer assemblies 40. For example, the grounding bar 61 is aligned with and extends along the apertures in the surface interface shield 60 for the wafer assembly 40A. The grounding bar 61 helps to reduce in-column crosstalk among the signal tail contact ends 401B-408B of the signal conductors 401-408 of the wafer assembly 40A. Additionally, the grounding bar 62 is aligned with and extends along the apertures in the surface interface shield 60 for the wafer assembly 40B. The grounding bar 63 is aligned with and extends along the apertures in the surface interface shield 60 for the wafer assembly 40C, and so on.

The grounding bars in the surface interface shield 60 also include SMT J-leads, which are aligned and positioned with the signal tail contact ends of the signal conductors in the wafer assemblies 40. The J-leads are sized and positioned to reduce cross-column crosstalk among the signal conductors between the wafer assemblies 40. For example, the grounding bar 61 includes J-leads 71-74. The J-lead 71 is positioned adjacent to the signal tail contact ends 401B and 402B, the J-lead 72 is positioned adjacent to the signal tail contact ends 403B and 404B, the J-lead 71 is positioned adjacent to the signal tail contact ends 405B and 406B, and J-lead 71 is positioned adjacent to the signal tail contact ends 407B and 408B.

FIG. 4C illustrates the view designated CC in FIG. 4B. As shown, the signal tail contact ends 401B and 402B extend through an aperture 65 in the surface interface shield 60. The shield tail contact ends 201B and 201BB also extend through the aperture 65. The J-lead 71 of the grounding bar 61 is positioned adjacent to the signal tail contact ends 401B and 402B. As measured from the front to the back of the connector 10, the length “L” of the J-lead 71 is the same as the distance measured from the front side surface of the signal tail contact end 402B to the back side surface of the signal tail contact end 401B. In other examples, the length “L” of the J-lead 71 can be larger than the distance between the outer side surfaces of the signal tail contact ends 401B and 402B, but the length “L” is preferably not shorter than that distance. The size of the J-lead 71 can be tailored or tuned to reduce crosstalk interference at the surface mating interface 14 of the connector 10.

As measured from the left to the right the connector 10, the width “W” of the shield tail contact ends 201B and 201BB is the same as the distance measured from the right side surface of the signal tail contacts 401A and 402B to the left side surface of the signal tail contact ends 401 A and 402B. In other examples, the width “W” of the shield tail contact ends 201B and 201BB can be larger, but the width “W” is preferably not shorter that shown. The size of the shield tail contact ends 201B and 201BB can be tailored or tuned to reduce crosstalk interference at the surface mating interface 14 of the connector 10.

FIG. 4D separately illustrates the surface interface shield 60 of the connector 10 shown in FIGS. 1A and 1B. As described above, the surface interface shield 60 includes a number of grounding bars, including the grounding bars 61-63, among others. The plated plastic material of the surface interface shield 60 can be molded around the grounding bars 61-63. The surface interface shield 60 includes one grounding bar for each of the wafer assemblies 40 in the connector 10. The surface interface shield 60 also includes a number of apertures that extend through the surface interface shield 60. Example apertures 65-68 are referenced individually in FIG. 4D, and the surface interface shield 60 includes a row of apertures for each of the wafer assemblies 40 in the connector 10.

Before turning to FIG. 5, it is noted that the connector 10 can vary as compared to the examples illustrated and described above. One or more parts or components of the connector 10 can be omitted in some cases. For example, the shield insert 300 can be omitted, the conductive gasket 390 can be omitted, or the shield plate 380 can be omitted from the connector 10. In another example, the conductive gasket 390 and the shield plate 380 can be omitted. Each of the wafer assemblies 40 can include additional channel shields or fewer channel shields than in the example shown. The connector 10 may also include other components that are not described and illustrated. Additionally, the connector 10 may include tail end contacts that are different than the J-shaped contacts, such as EON tail contacts, in some cases.

FIG. 5 illustrates another example wafer assembly 80 according to various aspects of the present disclosure. The wafer assembly 80 is similar to the wafer assemblies 40 described above. A number of wafer assemblies similar to the wafer assembly 80 can be used in a connector similar to the connector 10 described herein. Notably, the wafer assembly 80 includes tail end contacts that are formed as EON tail contacts in the example shown, and the embodiments described herein include tail end contacts formed as EON tail contacts.

Among other components, the wafer assembly 80 includes a wafer frame 100A, channel shields 251-254, and a shield insert 350. Although not shown in FIG. 5, the wafer assembly 80 can include a conductive gasket, a shield plate, or both on the backside of the wafer assembly 80. In other examples, the wafer assembly 80 can include another shield insert, similar to the shield insert 350, positioned at the backside of the wafer assembly 80. Thus, the embodiments described herein include wafer assemblies incorporating one, two, or more shield inserts.

The channel shields 251-254 include two 45° bends, as compared to the single 90° bends in the channel shields 201-204. The shield insert 350 can be formed as a plated plastic component, similar to the shield insert 300 described above. The shield insert 350 is designed to enclose the discontinuities at the bends in the channel shields 251-254. As shown, the shield insert 350 includes a first arm 351, a second arm 352, and a base arm 353. The first arm 351 extends to enclose the discontinuities at one bend in the channel shields 251-254, and the second arm 352 extends to enclose the discontinuities at another bend in the channel shields 251-254. The base arm 353 extends along the surface mating interface of the wafer assembly 80.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

1. A connector assembly, comprising:
a plug mating interface;
a surface mating interface; and
a wafer assembly between the plug mating interface and the surface mating interface, the wafer assembly comprising:
a wafer frame;
a channel shield;
a conductive shield insert positioned around the channel shield;
a plurality of signal conductors extending within the channel shield;
a conductive gasket positioned over open edges of the channel shield; and
a shield plate, wherein the conductive gasket is positioned between the shield plate and the open edges of the channel shield.

2. The connector assembly according to claim 1, wherein the conductive gasket comprises a conductive elastomeric gasket and provides a conductive shield over the open edges of the channel shield.

3. The connector assembly according to claim 1, wherein the shield plate comprises a plurality of positioning fingers extending from a peripheral edge of the shield plate.

4. The connector assembly according to claim 1, wherein the conductive shield insert is positioned around a corner region of the channel shield.

5. The connector assembly according to claim 1, wherein:
the channel shield comprises shield sidewalls and a shield discontinuity between the shield sidewalls; and
the conductive shield insert is positioned around the shield discontinuity between the shield sidewalls.

6. The connector assembly according to claim 5, wherein:
the wafer assembly further comprises a second channel shield;
the second channel shield comprises second shield sidewalls and a second shield discontinuity between the second shield sidewalls; and
the conductive shield insert is positioned around the shield discontinuity between the shield sidewalls of the channel shield and is positioned around the second shield discontinuity between the second shield sidewalls of the second channel shield.

7. The connector assembly according to claim 6, wherein the conductive shield insert electrically couples the channel shield and the second channel shield.

8. The connector assembly according to claim 6, wherein the conductive gasket is positioned over the open edges of the channel shield and over second open edges of the second channel shield.

9. The connector assembly according to claim 1, further comprising a surface interface shield positioned at the surface mating interface of the connector assembly.

10. The connector assembly according to claim 9, wherein the surface interface shield comprises a plated plastic.

11. The connector assembly according to claim 10, wherein, at the surface mating interface, the channel shield and the plurality of signal conductors extend through an aperture in the surface interface shield.

12. The connector assembly according to claim 11, wherein the surface interface shield comprises a grounding bar and a J-lead extending from the grounding bar.

13. A wafer assembly, comprising:
a wafer frame;
a channel shield comprising a shield discontinuity;
a plurality of signal conductors extending within the channel shield;
a conductive shield insert positioned around the shield discontinuity in the channel shield; and
a shield plate positioned over open edges of the channel shield.

14. The wafer assembly according to claim 13, further comprising a conductive gasket positioned between the shield plate and the open edges of the channel shield.

15. The wafer assembly according to claim 14, wherein the conductive gasket comprises a conductive elastomeric gasket and provides a conductive shield over the open edges of the channel shield.

16. The wafer assembly according to claim 15, wherein the conductive shield insert is positioned around a corner region of the channel shield.

17. A wafer assembly, comprising:
a wafer frame;
a channel shield comprising open edges;
a plurality of signal conductors extending within the channel shield;
a conductive gasket positioned over the open edges of the channel shield; and
a shield plate, wherein the conductive gasket is positioned between the shield plate and the open edges of the channel shield.

18. The wafer assembly according to claim 17, wherein the conductive gasket comprises a conductive elastomeric gasket and provides a conductive shield over the open edges of the channel shield.

19. The wafer assembly according to claim 17, wherein the shield plate comprises a plurality of positioning fingers extending from a peripheral edge of the shield plate.

20. The wafer assembly according to claim 17, further comprising a conductive shield insert positioned around the channel shield.
